(19) United States
(12) Patent Application Publication
(10) Pub. No.: US 2003/0102965 A1
(43) Pub. Date: Jun. 5, 2003

(54) Vehicle mountable device for detecting the reflecting characteristics of a surface

(75) Inventor: Yosef Hemed, Jerusalem (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: APOLLO LTD.

(21) Appl. No.: 09/998,648

(22) Filed: Dec. 3, 2001

(51) Int. Cl. G08G 1/123

(52) U.S. Cl. 340/435; 180/169

(57) ABSTRACT

A vehicle-mountable apparatus, for detecting the reflective characteristics of a surface, includes means for directing pulsed radiation at a predetermined wavelength and at a predetermined pulse frequency towards the surface; means for sensing radiation reflected from the surface; means, associated with the sensing means, for providing a predetermined output indication to a vehicle controller in response to sensed radiation of at least a predetermined intensity; and means for mounting at least the directing means and the sensing means onto a vehicle.

### FIELD OF THE INVENTION

The present invention relates generally to radiation detection apparatus and particularly to vehicle safety devices employing such apparatus for the detection of surfaces having selected radiation reflectance characteristics,

### BACKGROUND OF THE INVENTION

In the field of transportation in general, and particularly in the area of surface vehicle transportation* accidents are widespread, and often cause human casualties ad/or damage to property. Accidents such as occur with automobiles and trucks, for example, may take the form of collisions between two or more vehicles or between a single vehicle and a stationary object. A further type of accident is that which is caused by vehicles accidentally veering off a designated road surface onto rough terrain.

Although traffic authorities, at least in part, provide road markings, in the form of white or yellow painted lines, for example, for indicating the edges of roads and for demarcating areas reserved for different lanes of traffic, if a driver fails to observe such markings, he may drive across them and thereby endanger his own vehicle and/or other vehicles travelling in the vicinity thereof.

### SUMMARY OF THE INVENTION

The present invention seeks to provide a vehicle safety device employing apparatus for indicating the proximity of a vehicle to a surface, such as of a line painted on a road surface, having selected reflectance characteristics.

There is provided, therefore, in accordance with an embodiment of the invention, vehicle mountable apparatus for detecting the reflective characteristics of a surface including apparatus for directing pulsed radiation at a predetermined wavelength and at a predetermined pulse frequency towards a surface; apparatus for sensing radiation reflected from the surface; apparatus, associated with the apparatus for sensing, for providing a predetermined output indication to a vehicle controller in response to sensed radiation of at least a predetermined intensity; and apparatus for mounting the apparatus for directing and the apparatus for sensing onto a vehicle.

Additionally in accordance with an embodiment of the invention, the apparatus for directing includes apparatus for directing pulsed infra red radiation at a predetermined infra red wavelength, and the apparatus for sensing includes an infra red sensor operative to provide an electrical output corresponding to sensed infra red radiation at the predetermined wavelength.

Further in accordance with an embodiment of the invention, there is also provided apparatus for filtering the electrical output provided by the infra red sensor and operative to pass only that portion of the output having a pulse frequency approximately equal to the predetermined pulse frequency.

Additionally in accordance with an embodiment of the invention, there is also provided additional filter apparatus which is operative, in the presence of ambient infra red radiation at the predetermined wavelength to filter the electrical output provided by the infra red sensor so as to pass only that portion of the electrical output corresponding to a radiation intensity level below that of ambient infra red radiation at the predetermined wavelength.

There is also provided, according to an additional embodiment of the invention, a vehicle having apparatus for detecting the reflective characteristics of a surface including apparatus for directing pulsed radiation at a predetermined wavelength and at a predetermined pulse frequency towards a surface; apparatus for sensing radiation reflected from the surface; and apparatus, associated with the apparatus for sensing, for providing a predetermined output indication to a vehicle controller in response to sensed radiation of at least a predetermined intensity.

According to yet a further embodiment of the invention, there is provided a method of ensuring the safe operation of a vehicle by detecting the reflectance characteristics of a surface, the method including the steps of directing from the vehicle towards a surface, pulsed radiation having a predetermined wavelength and a predetermined pulse frequency; sensing radiation reflected from the surface; and providing a predetermined output indication to a vehicle controller in response to sensed radiation of at least a predetermined intensity.

### BRIEF DESCRIPTION OF THE DRAWINGS

The present invention will be more fully understood and appreciated from the following detailed description, taken in conjunction with the drawings, in which:

FIG. 1 is a schematic illustration of a vehicle safety device constructed and operative in accordance with the present invention:

FIG. 2 is a block diagram illustration of the device of FIG. 1;

FIG. 3 is art electrical circuit diagram of the device of FIGS. 1 and 2;

FIG. 4 is a schematic side view illustration of a vehicle employing the safety device of FIGS. 1-3; and

FIG. 5 is a schematic plan view illustration of the vehicle illustrated in FIG. 4.

### DETAILED DESCRIPTION OP THE INVENTION

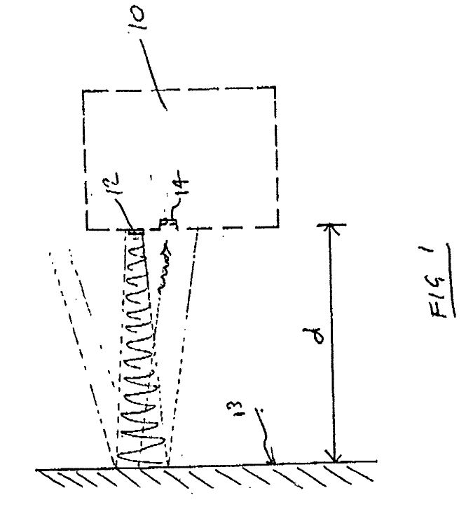

Reference is now made to FIGS. 1, 2 and 3 In which there is shown a vehicle safety device, referenced generally 10, constructed and operative in accordance with the present invention. As will be appreciated by persons skilled in the art, device 10 is intended, in particular, to aid prevention of traffic accidents. Among traffic accidents that may be prevented by use of the present invention are, for example, those accidents involving either a collision between two or more vehicles, or accidents caused by a driver inadvertently driving off a highway surface. Further applications of the invention, for example, in a computerized vehicle steering system, are also included in the scope of the present invention.

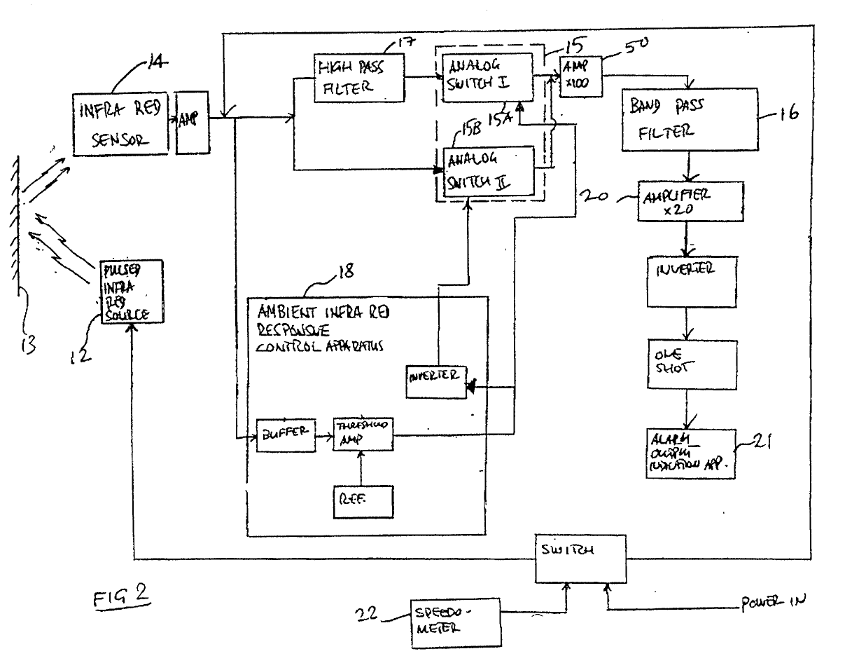

As shown in FIGS. 1 and 2, therefore, device 10 employs a radiation source 12, for directing pulses of radiation of a predetermined wavelength and at a predetermined pulse frequency, towards a surface 13 (FIG. 1). A radiation sensor 14 is also provided in proximity to the radiation source 12. Radiation directed at surface 13 is scattered thereby and a portion of the radiation is reflected towards the sensor, which is operative to provide an electrical output in accordance with the intensity of the sensed radiation.

According to a preferred embodiment of the invention, device 10 is operative, therefore, to direct radiation at a predetermined wavelength and at a predetermined pulsed frequency, towards a surface, typically from a predetermined distance from the surface. If the radiation is reflected from the surface back to device 10 at at least a minimum intensity, such as would be provided by reflection from a road marking, such as a white or yellow line, an alarm is activated.

It will be appreciated that at night there is negligible ambient radiation, and thus radiation sensed by radiation sensor 14 may be assumed to made up almost entirely of the radiation directed from source 12 towards the surface 13. During the daytime, however, the level of ambient radiation present is relatively high, and may be sufficient to activate the alarm when scattered from many different types of surface, and not just those that it is sought to detect. As the level of ambient daylight radiation is more or less predictable, the device of the present invention also includes a high pass filter 17 for neutralizing the effect of ambient radiation, having at least a predetermined intensity and at a wavelength similar to that of the radiation emitted from radiation source 12.

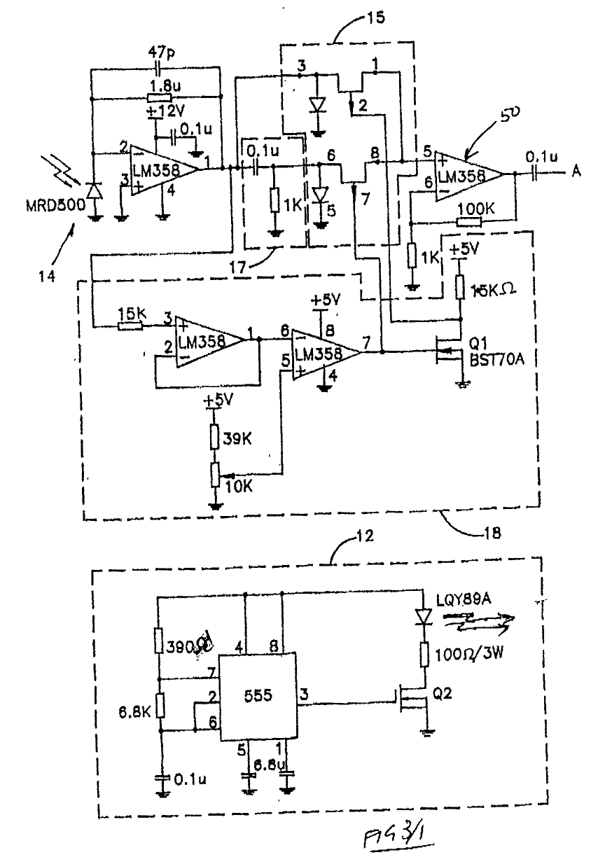

The electrical output from radiation sensor 14 is thus passed, via an analog switch unit 15, via an amplifier 50 to a bandpass filter 16. A typical analog switch unit suitable for use in the present invention is an AH5012 analog switch manufactured by National Semiconductor Inc., Japan, illustrated in FIG. 3, the electrical output passed via the analog switch unit is passed through either of the units constituents switches, referenced 15A and 159 and is thus accordingly either passed via high pass filter 17, or around it. This depends, as described above, on the intensity of the ambient radiation, and is governed by ambient radiation responsive control apparatus 18, as described below.

Control apparatus 18 samples the electrical output of sensor 14 via a buffer, as shown, and a threshold amplifier. If the input voltage into amplifier is less than the predetermined threshold value thereof, indicating no substantial ambient radiation at the wavelength of the radiation emitted from source 12, then a ‘zero’ is received at the output of the threshold amplifier so as to cause disconnection of analog switch 15A, so as to cause the electrical output from sensor 14 to circumvent the high pass filter 17.

If, however, the input voltage into threshold amplifier is greater than the predetermined threshold value thereof, such as would be received in the presence of substantial ambient radiation at the wavelength of the radiation emitted from source 12, then a voltage inverter, also shown in FIGS. 2 and 3, is operative to disconnect analog switch 15B, and the electrical output from sensor 14 is passed through high pass filter 17 and analog switch 15A.

According to a preferred embodiment of the invention, the radiation provided from source 12 is infra red radiation at a wavelength of typically 930 nm provided at a pulse frequency of approximately 1.0 to 1.2 kHz. An example of a suitable LED is part no. CQY89A manufactured by Phillips Inc., Holland, and an example of a suitable radiation sensor is an MRD 500 Pin Silicon Photodiode manufactured by National Semiconductor, Japan.

The portion of the electrical input provided to bandpass filter 16 and having a pulse frequency similar to the pulse frequency at which the radiation was emitted from source 12, is thereafter provided, via an amplifier 20 (FIG. 3), to alarm output indication apparatus 21. If the input into alarm apparatus 21 has at least a predetermined minimum intensity, an alarm output indication will be provided to a vehicle controller. Typically, the output indication is an audible alarm, such as provided by a conventional-type buzzer, although it may be any alternative type of alarm, either audible or visual, as known in the art. Although the vehicle controller referred to herein is typically a human operator it will, however, be appreciated that the vehicle controller may alternatively be an automatic steering system.

It will be appreciated by persons skilled in the art that, the radiation source and the sensor must be located at a predetermined distance ‘d’ from the surface 13. Construction of the device 10 as shown specifically in FIG. 3 requires d to be about 30-40 cm when distinguishing between white or yellow road markings and the remainder of a road surface. It will be appreciated by persons skilled in the art that, construction of the device 10 using components having values different to those shown in FIG. 3 may also cause a change in distance d.

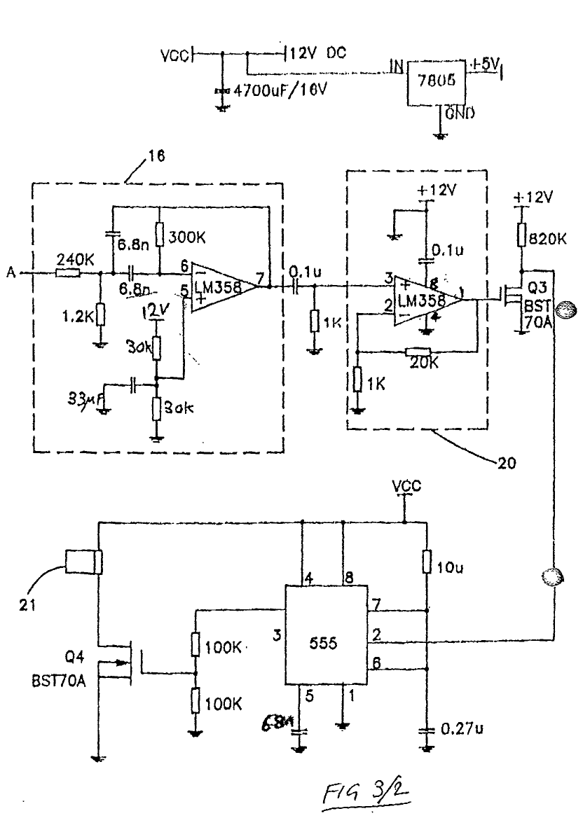

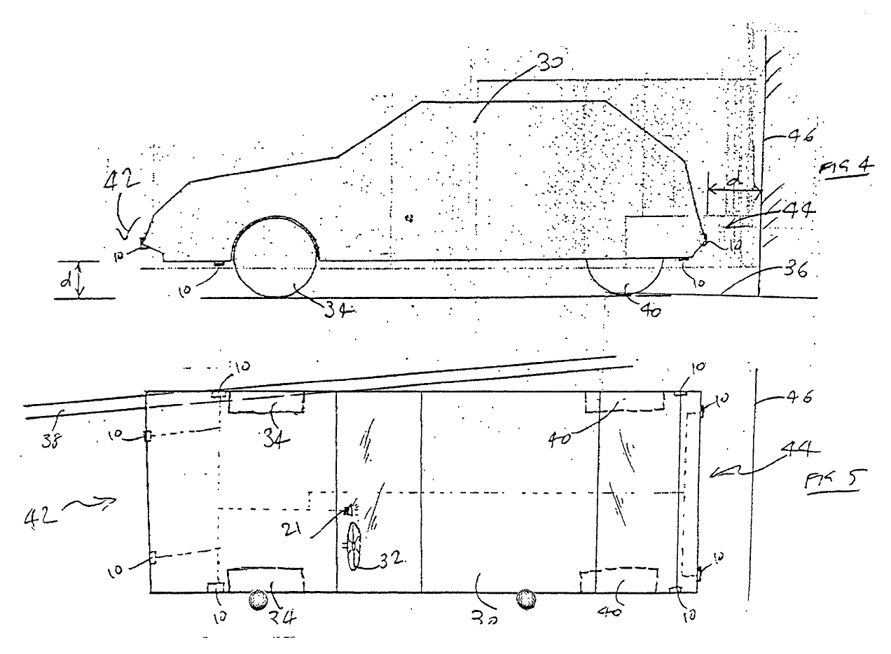

Although reflective surfaces such as are sought to be detected by the present invention are detectable at a predetermined distance from the device, even generally nonreflective surfaces, which are not detectable at the predetermined distance, may be detected if device 10 of the invention is brought sufficiently close thereto. Thus, as described below in conjunction with FIGS. 4 and 5, a rearward looking device, for example, may be useful when reversing a vehicle slowly into a parking space, adjacent to which is a parked vehicle or other stationary object. Although the object may not be particularly reflective and, therefore, no alarm indication will be provided at the above-mentioned distance of 30-40 cm, the object will, however, be detected at a shorter distance, thereby enabling the vehicle driver to prevent a collision between his vehicle and the stationary object.

Referring now to FIGS. 4 and 5, there are shown respective side and plan views of a vehicle, referenced generally 30, employing a number of the devices 10 of the present invention, typically connected to a single alarm output indication unit 21, shown, in the present example, to be located in the vicinity of steering wheel 32 (FIG. 5) of the vehicle.

In the present example, two devices 10 are mounted immediately in front of the respective front wheels 34 of the vehicle at a height of about 30-40 cm above a highway or other designated travel surface 36 (FIG. 4).

In operation, as long as the vehicle remains constantly within the confines of one demarcated lane of the highway surface, no alarm indication will be provided, as the infra red radiation directed at the highway surface will not be reflected at an intensity sufficient to activate the alarm apparatus 21.

As soon as the vehicle maneuvers in such a way as to cross a sufficiently reflective surface, as shown at 38 (FIG. 5), such as a white or yellow painted on the highway surface, (the yellow line conventionally including light reflective particles), infra red radiation will be reflected therefrom. Accordingly, the sensor 14 will provide an electrical output which, as described in detail above in conjunction with FIG. 3, will activate the alarm unit 21, of an alarm indication.

According to one embodiment of the invention, the device 10 of the present invention is operatively associated with a portion of the vehicle, such as its speedometer 22 (FIG. 2), so as to be operative only when the vehicle is travelling at least a minimum predetermined speed, such as 60 km/h, consistent with highway driving.

Activation of the alarm indication unit 21 is operative to warn the vehicle driver that the vehicle is crossing a white or yellow line, or another form of road marking generating the alarm indication. If the crossing of the road marking was unintentional, such as if the road marking was a yellow line indicating the edge of the highway, or if the road marking were a white line either demarcating opposing lanes of traffic or indicating a junction boundary, the driver may correct his mistake, thereby averting a possible accident.

Similarly, two devices are mounted immediately to the rear of the respective rear wheels 40 of the vehicle at a height of about 30-40 cm above highway surface 36. These rear located devices may aid a driver in rear maneuvers, such as when parking a vehicle in a marked parking space.

Further devices are mounted at respective front and rear extreme portions 42 and 44 of the vehicle, and are mounted so as to be generally forward facing and rearward facing respectively. It will be appreciated that the forward and rear facing devices are useful in reducing the likelihood of a collision occurring between the vehicle and either a slow-moving or stationary object, such as a wall 46 or a stationary vehicle, whether the vehicle 30 is travelling forward or in reverse. As described above, although detection of a generally nonreflective object will not occur at the ‘prescribed’ distance of 30-40 cm, such an object will nonetheless be detected, albeit at a shorter distance.

It will be appreciated by persons skilled in the art, that the scope of the present invention is not limited to what has been specifically shown and described hereinabove, by way of example The scope of the present invention is limited, rather, solely by the claims, which follow: sensor operative to provide an electrical output corresponding to sensed infra red radiation at said predetermined wavelength.

5. Apparatus according to claim 9, and also comprising:
means for filtering the electrical output provided by said infra red sensor and operative to pass only that portion of the output having a frequency approximately equal to said pulse frequency.

6. Apparatus according to claim 5, and also comprising additional filter means which is operative, in the presence of ambient infra red radiation at said predetermined wavelength, to filter the electrical output provided by said infra red sensor so as to pass only that portion of the electrical output corresponding to a radiation intensity level below that of ambient infra red radiation at said predetermined wavelength.

7. A vehicle having apparatus for detecting the reflective characteristics of a surface comprising:
at least one means for directing pulsed radiation at a predetermined wavelength and at a predetermined pulse frequency towards a surface;
at least one means for sensing radiation reflected from the surface; and
means, associated with each of at least one said means for sensing, for providing a predetermined output indication to a vehicle controller in response to sensed radiation of at least a predetermined intensity.

8. A vehicle according to claim 7, and also including means for mounting each said means for directing and each said means for sensing onto a vehicle at a predetermined distance from the surface.

9. A vehicle according to claim 7, and wherein said means for providing a predetermined output indication comprises means for providing a sensible alarm indication.

10. A vehicle according to claim 8, and wherein each said means for directing comprises means for directing pulsed infra red radiation at a predetermined infra red wavelength, and each said means for sensing comprises an infra red sensor operative to provide an electrical output corresponding to sensed infra red radiation at said predetermined wavelength.

11. A vehicle according to claim 10, and also comprising:
means for filtering the electrical output provided by each said infra red sensor and operative to pass only that portion of the output having a frequency approximately equal to said pulse frequency.

12. A vehicle according to claim 11, and also comprising additional filter means which is operative, in the presence of ambient infra red radiation at said predetermined wavelength, to filter the electrical-output provided by said infra red sensor so as to pass only that portion of the electrical output corresponding to a radiation intensity level below that of ambient infra red radiation at said predetermined wavelength.

13. A method of ensuring the safe operation of a vehicle by detecting the reflectance characteristics of a surface, said method comprising the following steps:
directing from the vehicle towards a surface, pulsed radiation having a predetermined wavelength and a predetermined pulse frequency;
sensing radiation reflected from the surface; and
providing a predetermined output indication to a vehicle controller in response to sensed radiation of at least a predetermined intensity.

14. A method according to claim 13, and wherein said step of directing comprises the step of directing radiation towards the surface at a predetermined distance therefrom, and said step of sensing includes the step of sensing the radiation reflected from the surface also at the predetermined distance therefrom.

15. A method according to claim 13, and also including the step of providing a sensible alarm indication at the interior of the vehicle in response to the provision of said predetermined output indication.

16. A method according to claim 15, and wherein said step of directing comprises the step of directing infra red radiation, and step of sensing comprises sensing infra red radiation reflected from the surface and providing an electrical output corresponding to sensed infra red radiation.

17. A method according to claim 16, and also comprising the step of filtering the electrical output corresponding to the sensed infra red radiation so as to pass only that portion of the output having a frequency approximately equal to said pulse frequency.

18. A method according to claim 17, and also comprising an additional step of filtering the electrical output corresponding to the sensed infra red radiation, so as to pass only that portion of the output not corresponding to the level of ambient infra red radiation.

1. Vehicle mountable apparatus for detecting the reflective characteristics of a surface comprising:
means for directing pulsed radiation at a predetermined wavelength and at a predetermined pulse frequency towards a surface;
means for sensing radiation reflected from the surface; means, associated with said means for sensing, for providing a predetermined output indication to a vehicle controller in response to sensed radiation of at least a predetermined intensity; and
means for mounting at least said means for directing and said means for sensing onto a vehicle.

2. Apparatus according to claim 1, and wherein said means for mounting comprises means for mounting said means for directing and said means for sensing onto the vehicle at a predetermined distance from the surface.

3. Apparatus according to claim 1, and wherein said means for providing a predetermined output indication comprises means for providing a sensible alarm indication.

4. Apparatus according to claim 2, and wherein said means for directing comprises means for directing pulsed infra red radiation at a predetermined infra red wavelength, and said means for sensing comprises an infra red sensor operative to provide an electrical output corresponding to sensed infra red radiation at said predetermined wavelength.

5. Apparatus according to claim 4, and also comprising:
means for filtering the electrical output provided by said infra red sensor and operative to pass only that portion of the output having a frequency approximately equal to said pulse frequency.

6. Apparatus according to claim 5, and also comprising additional filter means which is operative, in the presence of ambient infra red radiation at said predetermined wavelength, to filter the electrical output provided by said infra red sensor so as to pass only that portion of the electrical output corresponding to a radiation intensity level below that of ambient infra red radiation at said predetermined wavelength.

7. A vehicle having apparatus for detecting the reflective characteristics of a surface comprising:
at least one means for directing pulsed radiation at a predetermined wavelength and at a predetermined pulse frequency towards a surface;
at least one means for sensing radiation reflected from the surface; and
means, associated with each of at least one said means for sensing, for providing a predetermined output indication to a vehicle controller in response to sensed radiation of at least a predetermined intensity.

8. A vehicle according to claim 7, and also including means for mounting each said means for directing and each said means for sensing onto a vehicle at a predetermined distance from the surface.

9. A vehicle according to claim 7, and wherein said means for providing a predetermined output indication comprises means for providing a sensible alarm indication.

10. A vehicle according to claim 8, and wherein each said means for directing comprises means for directing pulsed infra red radiation at a predetermined infra red wavelength, and each said means for sensing comprises an infra red sensor operative to provide an electrical output corresponding to sensed infra red radiation at said predetermined wavelength.

11. A vehicle according to claim 10, and also comprising:
means for filtering the electrical output provided by each said infra red sensor and operative to pass only that portion of the output having a frequency approximately equal to said pulse frequency.

12. A vehicle according to claim 11, and also comprising additional filter means which is operative, in the presence of ambient infra red radiation at said predetermined wavelength, to filter the electrical output provided by said infra red sensor so as to pass only that portion of the electrical output corresponding to a radiation intensity level below that of ambient infra red radiation at said predetermined wavelength.

13. A method of ensuring the safe operation of a vehicle by detecting the reflectance characteristics of a surface, said method comprising the following steps:
directing from the vehicle towards a surface, pulsed radiation having a predetermined wavelength and a predetermined pulse frequency;
sensing radiation reflected from the surface; and
providing a predetermined output indication to a vehicle controller in response to sensed radiation of at least a predetermined intensity.

14. A method according to claim 13, and wherein said step of directing comprises the step of directing radiation towards the surface at a predetermined distance therefrom, and said step of sensing includes the step of sensing the radiation reflected from the surface also at the predetermined distance therefrom.

15. A method according to claim 13, and also including the step of providing a sensible alarm indication at the interior of the vehicle in response to the provision of said predetermined output indication.

16. A method according to claim 15, and wherein said step of directing comprises the step of directing infra red radiation, and step of sensing comprises sensing infra red radiation reflected from the surface and providing an electrical output corresponding to sensed infra red radiation.

17. A method according to claim 16, and also comprising the step of filtering the electrical output corresponding to the sensed infra red radiation so as to pass only that portion of the output having a frequency approximately equal to said pulse frequency.

18. A method according to claim 17, and also comprising an additional step of filtering the electrical output corresponding to the sensed infra red radiation, so as to pass only that portion of the output not corresponding to the level of ambient infra red radiation.
